(19) United States
(12) Patent Application Publication
(10) Pub. No.: US 2012/0324511 A1
(43) Pub. Date: Dec. 20, 2012

(54) APPARATUS, SYSTEM FOR SCHEDULING AND BROADCASTING MEDIA, AUTOMATIC CHANNEL SCHEDULING METHOD AND RECORDING MEDIUM

(76) Inventors: Sih-Ping KOH, Taipei City (TW); Feng-Shiuh SONG, Taipei City (TW); Bo-Zhou LIN, Taipei City (TW); Chien-An CHEN, Taipei City (TW)

(21) Appl. No.: 13/163,834

(22) Filed: Jun. 20, 2011

(51) Int. Cl. H04N 5/445

(52) U.S. Cl. 725/53; 725/39

(57) ABSTRACT

Disclosed are an apparatus and a system for scheduling and broadcasting media, and an automatic channel scheduling method. In particular, the disclosure is applied to establishing a scheduling and broadcasting system for digital content over a data network, such as to an enterprise. An automatic channel scheduling method is disclosed. A step in the method is to generate a content broadcasting request. Then the step is to acquire information related to the content from a resource, and to store the content. The system is to configure the broadcasting channel, object to be distributed, type to broadcast, and the broadcasting time in accordance with the request and attribute of the content. Consequently, the content is broadcasted to the one or more chosen terminal display devices.

### BACKGROUND OF THE INVENTION

1. Field of the Invention

The instant disclosure relates to a media scheduling and broadcasting apparatus, system, automatic channel scheduling method, and a recording medium thereof, more particularly to the apparatus, system and method for establishing channels, retrieving digital content, scheduling and broadcasting media.

2. Description of Related Art

The conventional way to establish a media channel and to broadcast the media thereof are generally implemented by a traditional television station. It costs much and not proper for the average persons. However, since the widespread use of Internet and its getting higher bandwidth, the media broadcasted over the network is gradually possible to the general persons.

In general, the conventional way to play or broadcast the media over the network is usually upon to the display of television or computer. However, the current trend is to broadcast the media up to a personal portable device.

In view of the published prior art, some conventional technologies had disclosed some methods to broadcast the digital content over the network. One of the methods is referred to FIG. 1 which schematically shows the digital video sent from a set top box to a wireless device.

FIG. 1 discloses a technology which delivers the video signals to a terminal over a network. A system 10 used to distribute video signals is shown. A video-end device 102 of the system 100 includes a media server 105 and a portal server 103. The video-end device 102 is especially connected with a cabled system, a satellite system or an Internet Protocol Television system (IPTV), thereby receiving the video signals therefrom. The media server 105 may connect to a set top box 104 or some other digital signal converters over a video network 106. The portal server 103 connects to a wireless device 108 over a wireless network 110.

According to the current example, the video-end device 102 may separately transmit media signals to the shown set top box 104 or to the wireless device 108 over the various network systems or different channels. Therefore, users may use the set top box 104 to request any TV or media program. The video-end device 102 may afterward receive the content and deliver the requested content through the media server 105.

Further, the user of the wireless device 108 may send a request, and the portal server 103 accordingly retrieves content from the media providers connected to the video-end device 102. Those channels are especially used for broadcasting the content.

Some conventional technologies had provided to broadcast the digital content, and especially to the proprietary terminal devices only. As to the most enterprises or organizations, it is difficult neither to establish nor to manage a medium or communication platform or any television channel within a range of specific cost. Further, the conventional way may not efficiently manage the content in the enterprise, and even not easily to distribute to any terminal device.

### SUMMARY OF THE INVENTION

In the disclosure, a specific channel management scheme is introduced to broadcasting digital content to the various terminal devices. A media scheduling and broadcasting apparatus, a system and an automatic channel scheduling method are provided to integrate a plurality of functions including retrieval of media data, management of content, channel scheduling, configuration of layout broadcasting, and cross-platform displaying into one scheme.

The media scheduling and broadcasting apparatus is particularly to provide users to perform channel management. Also, the apparatus is used for scheduling digital content and broadcasting the content over a network. After that, the digital content can be broadcasted to public display, personal computer, and the screen of mobile device. The apparatus is able to constitute a platform with multiple communication technologies, and to record the content of broadcasting channel for future reproduction.

According to one of the embodiments in accordance with the instant disclosure, the provided media scheduling and broadcasting apparatus includes a content capturing module for retrieving the digital content from a digital content source. The apparatus also includes a content management module for providing services of searching and browsing the content from the content capturing module. Further, the apparatus includes a channel management module for configuring the broadcasting channel. Still further, the apparatus includes a program scheduling module for scheduling the content in accordance with time information. In one embodiment, the media scheduling and broadcasting apparatus is configured to have a layout configuration module for configuring the displaying layout for the display screen of the terminal display device. A playback-end management module is particularly introduced to automatically regulating the way to broadcast the digital content based on the specification of terminal display and its playing condition.

In accordance with one further embodiment of the disclosure, the described media scheduling and broadcasting apparatus essentially includes a content capturing module for retrieving the digital content produced by a digital content source, a content storing unit for storing the digital content, a content management module prepared for searching and browsing the stored digital content, a channel management module for configuring the broadcasting channels for the content, a program scheduling module for scheduling the program in accordance with time information, a codec module for automatically converting the digital content to the format adapted to the terminal display device, a layout configuration module for arranging the displaying layout of the terminal display device, and a playback-end management module for managing the display and playback conditions and automatically regulating the delivering method of the digital content. While the content is broadcasted over the network, the system may broadcast the content in the form of streaming to one or more terminal display devices in accordance with the settings made by a content streaming module. The setting may include the related broadcasting channel, object(s) to be distributed, and time to broadcast. A file delivery module is further introduced to delivering the digital content in form of a file to a media player in accordance with the broadcasting channel, the object(s) to be distributed and broadcasting time.

Not only the media scheduling and broadcasting apparatus is included to constitute the system, but also a digital content source, a management system connected with the apparatus, and one or more terminal display devices. The terminal display device may be an digital bulletin board, a terminal computer or a mobile device. The system may distribute the content as a streaming video/audio, a file, or in form of video/audio on demand.

According to one of the embodiments, the abovementioned apparatus and the system implement a method of scheduling channel. A first step in the method is to generate a digital content broadcasting request through the management system. The request may also be generated conducted by the message recorded in the mail from a mail server.

The system at the next step in the method is to receive the information of the digital content. The content is then stored in the system. Based on the request, one or more broadcasting channels, one or more objects to be distributed, one or more types to broadcast, and one or more broadcasting time are configured to conduct the digital content. The system then broadcasts the content to every terminal display device according to the required channel(s), object(s), type(s), and the corresponding time.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of a conventional system for broadcasting digital video;

FIG. 2 schematically shows structure of a media scheduling and broadcasting system in accordance with the instant disclosure;

FIG. 3 shows a schematic diagram describing concept of the media scheduling and broadcasting system in accordance with the instant disclosure;

FIG. 4 is a diagram describing one embodiment of the system of scheduling and broadcasting media of the instant disclosure;

FIG. 5 illustrates a block diagram of one embodiment of the media scheduling and broadcasting apparatus in accordance with the instant disclosure;

FIG. 6 illustrates a second block diagram of one further embodiment of the apparatus in accordance with the instant disclosure;

FIG. 7 illustrates functional blocks among software modules of the media scheduling and broadcasting apparatus of the instant disclosure;

FIG. 8 illustrates the functional blocks of one further embodiment of the media scheduling and broadcasting apparatus of the instant disclosure;

FIG. 9 is a diagram showing a customized schedule of the received digital content;

FIG. 10 illustrates a flow chart of one embodiment of the automatic scheduling method for the media to be broadcasted.

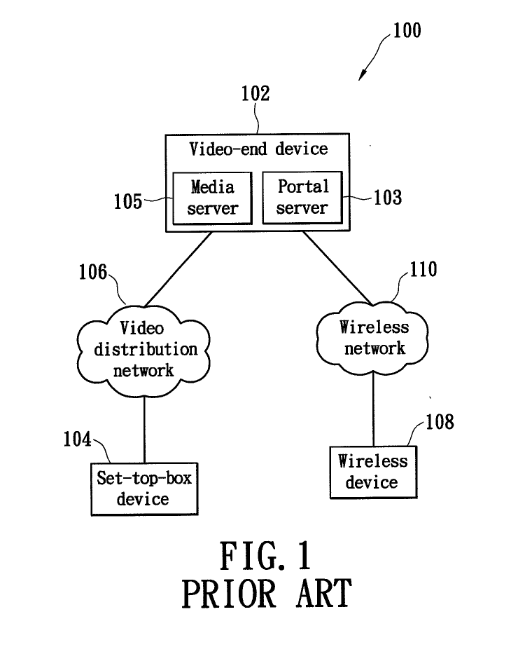

### DETAILED DESCRIPTION OF THE PREFERRED EMBODIMENTS

In accordance with the requirement of establishment of digital content channels and content management, disclosed herein in the disclosure are a media scheduling and broadcasting apparatus, a system and a method for automatically scheduling the channels. The related scheme is preferably provided for media asset management, program scheduling, network virtual conference, and establishment of channels. In particular, means of channel management is introduced into the scheme for broadcasting the digital content to various terminal devices. Also, the scheme is able to retrieve the media content, manage the content, schedule the channels, arrange the playback layout, and display the media over various platforms.

A platform in this disclosure is for users or administrators to establish schedule and broadcast the digital content. The establishment of channels is particularly for the users conveniently managing the various contents. The mentioned digital content may be the content converted from traditional TV program, the digital video signals, audio signals, picture, or text. The end object to be broadcasted may be a personal handheld mobile device, a television, a terminal computer, a digital signage, or a bulletin board at public place.

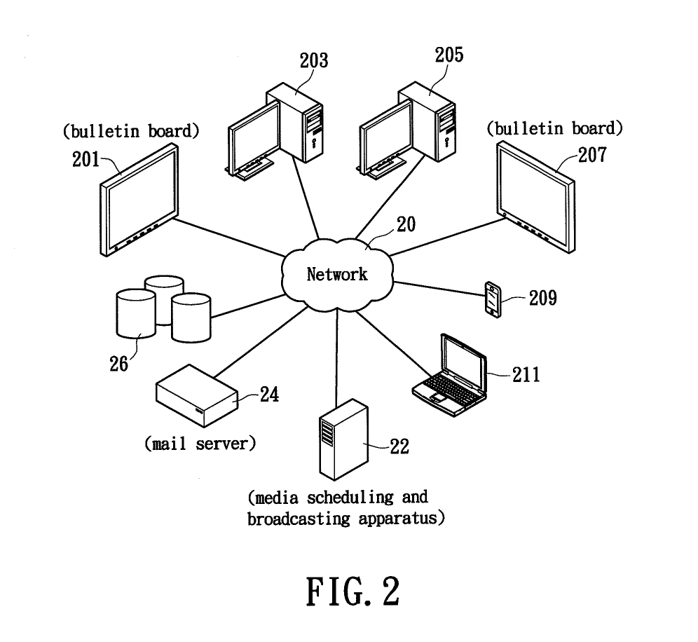

The platform may be referred to the structure describing media scheduling and broadcasting system shown in FIG. 2. The shown system is implemented over a network 20. A media scheduling and broadcasting apparatus 22 is connected to the network 20. This media scheduling and broadcasting apparatus 22 performs digital content channel management, program scheduling, content management, playing terminal device management, layout arrangement configuration, content retrieving, real-time encoding/decoding, audio-visual streaming, file delivery, digital content format conversion, playback recording, and storage through an operating system and its installed software module. Those functions may be implemented through the corresponding software program, or electric circuits.

In one embodiment, the media scheduling and broadcasting apparatus 22 may be a single device. One further embodiment is implemented as a cluster constituted of a plurality of computer systems, or even an aspect of cloud computing.

Through the network 20, in one embodiment, the above-described media scheduling and broadcasting system is connected with the terminal display devices. The terminal display device may be implemented as several types, such as a PC-based platform, a mobile device, or a platform with public display system. The media scheduling and broadcasting system may conduct a channel type to broadcast the digital content in compliance with the attribute of content, or based on the type of the every terminal display device. The mentioned channel type may be a live channel, an on-demand channel, an interactive channel, or an online conference channel.

For example, the terminal display device may be a digital bulletin board 201, 207 mounted at a public area. The device may also be a personal computer 203, 205, a handheld mobile device 209, or a notebook computer 211. Furthermore, the terminal display device may be an apparatus with display, such as a television, an electronic book device, or a digital album device.

In one embodiment, a mail server 24 is exemplarily provided to accomplish program scheduling of the digital content. For example, a user writes an electronic mail through a computer system. The mail may be attached with a video file. The user may use a scheduling function of the electronic mail agent to set up a time to play the video file, and any object to be broadcasted. The above-mentioned personal device or any public display device is one of the objects. After delivering the electronic mail, the related content will be queued in the mail server 24.

According to one of the embodiments, the described media scheduling and broadcasting apparatus 22 may be integrated with the mail server 24. In which, a software program is used to access the mail server 24 periodically. The software program may automatically extract the attachment and to-do list from the mail server. This program is further linked with the routine which handles the program scheduling. Therefore, the apparatus 22 may timely receive the request of broadcasting the digital content. Since the sent electronic mail is resolved, the media scheduling and broadcasting apparatus 22 accordingly schedules, format-converts, and then broadcasts the media to the object(s) desired to be distributed in compliance with time and the object set in the mail.

FIG. 2 describes an embodiment associated with the technology of the instant disclosure. The above-mentioned mail may contain the digital content with the type of audio/video, voice, picture, or text. The disclosed system broadcasts the content to the terminal. The digital content, in an exemplary example, may be a file stored in one specific position. This position may be a database not shown in the figure, or a file server 26 storing various media files. The content includes education and training content, promotion information, bulletin information, advertisement and others. In this case, the user may record a link for the specific content into the mail. After delivering the mail, the media scheduling and broadcasting apparatus 22 performs scheduling and broadcasting.

According to one of the embodiments, a message push/pull technology may be introduced into the media scheduling and broadcasting apparatus for actively pushing the digital content to the specified terminal display device. One further embodiment is to broadcast the digital content to the various terminal display devices by a live streaming technology. When the live streaming technology is adopted, the content file may have a bigger size and require longer time to deliver. Further, the live video may also require the streaming technology.

For example, the TV program may use the disclosed system to broadcast the content to the terminal device through a streaming service.

Furthermore, the streaming service may be conducted as the time to deliver the digital content is scheduled. The streaming service may be suitable for the video-on-demand or media-on-demand service made by an end user. It starts to deliver or download the content after the user makes a selection.

The various formats supported by the disclosed system may not be limited to any specific format. It is featured that the system considers the specification or property of the every terminal display device, and provides the content with a suitable format. The format may be specified for Video/Audio, Graphic/Image, HTML Web Pages, RSS, Office Document (doc, ppt, xls, visio), or Mail/MMS/SMS.

The described system platform may be established in an enterprise or an organization. The platform may integrate the digital content asset within the enterprise or organization, and provide low-cost scheme to establish the internal channels for delivering the digital content. Thus the scheme provides an efficient way to improve the internal communication and information distribution, and also decrease the geographic limitation within and outside the enterprise. The scheme is featured that the content management and distribution are integrated into the system, and the system provides each terminal device a corresponding file format and its broadcasting method. In particular, the above-described operations are mostly performed automatically and having low cost.

The media scheduling and broadcasting apparatus 22 is particularly provided for users to perform channel management, by which the various digital contents are categorized into different kinds. For example, the categories may comply with the types of the various terminal display devices, such as a channel for playback in personal computer, a channel for mobile communication device, and a channel for public display. According to one further embodiment, the digital content may also be categorized in compliance with the departments or zones of the terminal display devices. Based on the categorization of the channels, the digital content can be scheduled and broadcasted onto the public display, display of personal computer, display of the specific mobile device over the network. Furthermore, a platform for multi-party communication may be established. The broadcasting content within any channel can be recorded for further reproduction.

It is noted that the disclosure may be not limited to the above described scheme using the electronic mail for delivering the broadcasting configuration and content, but also using a webpage interface for the administrators to manage the channels for broadcasting the content through the media scheduling and broadcasting apparatus 22. Also, a mobile phone may be used to transmit commands or perform remote control.

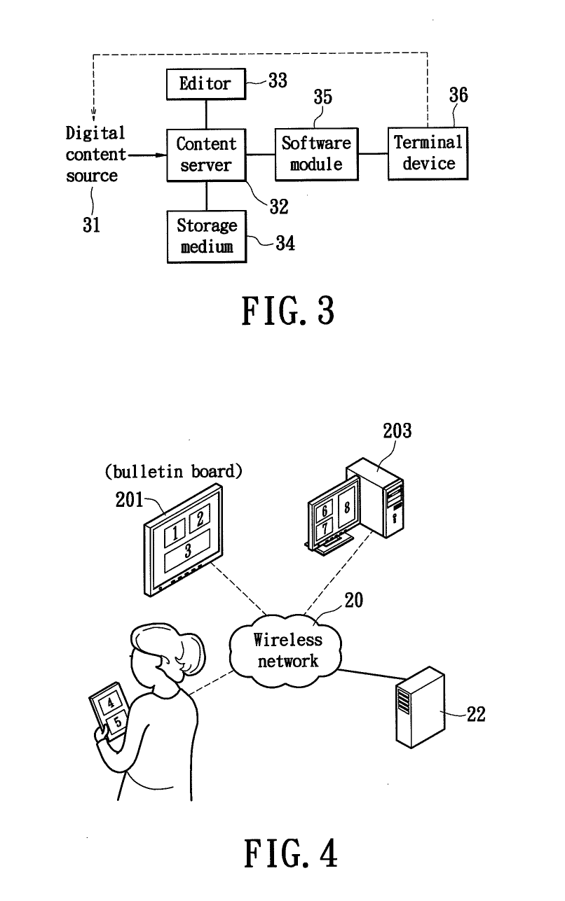

One aspect of the instant disclosure is particularly shown in FIG. 3. In which, a schematic diagram describing the media scheduling and broadcasting system provides a content server 32, which is able to retrieve information from the various digital content sources 31. The information content source may be the mentioned mail server, the file server, or database having content being provided by a particular content provider, uploaded by any user, or extracted from live TV program. The content is then broadcasted from the system after a suitable conversion. Some other content sources may not be restricted, such as the instant message about the TV program, or the content shared from other users. Still further, an RSS (Really Simple Syndication) method for retrieving the integration of the various information. Further, the content may be the data synchronized with the public community such as Youtube®, Facebook®, Twitter®, or the like. These mentioned contents may be prepared for the content server 32 to distribute.

The retrieved content may be stored in a storage medium 34. Before the digital content input into the content server 32, the content is firstly edited by an editor 33. Particularly, the content is edited to the file compatible with the system and able to be broadcasted. Or, the content is edited in compliance with the specification and the compatible format of each terminal device 36.

After that, those mentioned software modules 35 of the media scheduling and broadcasting system are used to perform the procedures including scheduling, editing, layout arrangement, establishment of playing channels, and searching. Then the content is broadcasted to the specified terminal device(s) 36. Reference is made to description of the FIG. 2. A method of streaming download may be used to broadcast the content to the each device. During the period of playing the content in each device, a recording function is employed to record the content played on the display, and the record may be reproduced again. The content server 32 may then retrieve, store and broadcast the recorded data.

In an exemplary example, reference is made to FIG. 4 showing the exemplary operation, several terminal displaying methods are disclosed.

The media scheduling and broadcasting apparatus 22 broadcasts the various content over the network 20, and is configured to display the content onto a specific terminal device. Firstly, the media scheduling and broadcasting apparatus 22 performs channel establishment and categorization as required. For example, the content displayed on the public bulletin board may not different from both the content displayed on the screen of the personal mobile device 209 and on the display of the personal computer 203 disposed in a fixed position.

The digital bulletin board 201 is usually disposed at a public area. The content under a layout arrangement, as shown in the figure, may include various information correspondingly displayed onto the different display zones 1, 2, 3, and the information is particularly regarding the public. The information may not only be a subject to each content, but also the messages regarding a video, still image, text, or instant information. The displayed content may be flexibly adjusted in accordance with the position the bulletin board 201 is disposed. In general, the public bulletin board may display the public information for any specific department or area.

The mentioned mobile device 209 may be configured to have the shown display zones 4, 5. The display of the mobile device 209 usually shows the customized information such as the information relating to his department of company, training courses, and work progress. The shown information may also be the video, still picture, text or any instant information.

The content displayed onto the personal computer 203 may be divided into several parts on the display zones 6, 7, 8. The information may include training content, department news, and meeting information. The content may also be a video, still picture, text or instant information.

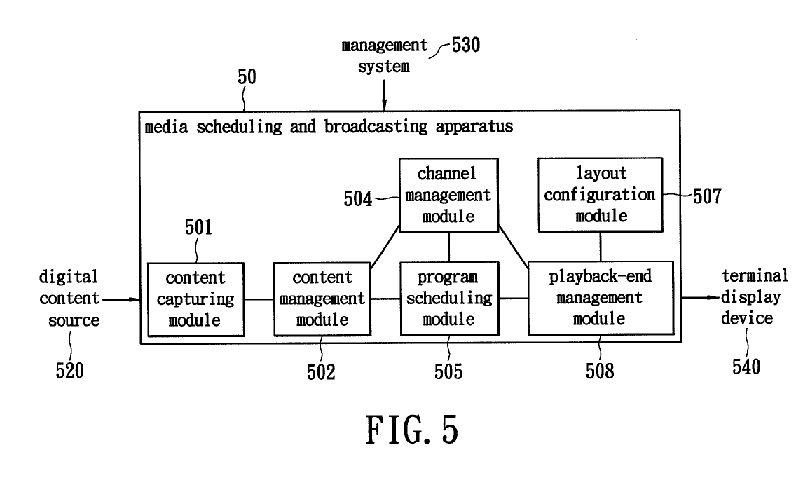

Operation of the media scheduling and broadcasting apparatus is preferably through some software modules, which are described as the functional blocks shown in FIG. 5.

A media scheduling and broadcasting apparatus 50 shown in FIG. 5 is implemented by a standalone computer system, or a cluster constituted of a plurality of computer systems, or achieved by a cloud-computing system. The operation may be described as the shown functional blocks representing the software modules, or the related circuit units.

The media scheduling and broadcasting apparatus 50 is externally connected with a digital content source 520. The apparatus 50 receives digital signals from the digital content source 520 which may be a file server, a database, a mail server, or the digital content provider over a network. Further, the content may also be the live TV program that may be converted to the digital content compatible to the apparatus 50.

The media scheduling and broadcasting apparatus 50 is further connected with a management system 530. The management system 530 may access this media scheduling and broadcasting apparatus 50 remotely or locally through a connection. For example, a web page is prepared for this apparatus 50 for users getting on. Through the web interface, it is able to be managed or configured. The media scheduling and broadcasting apparatus 50 is also connected to the various types of terminal display devices 540. The terminal device may be a bulletin board, personal mobile device or any computer device.

The media scheduling and broadcasting apparatus 50 and its connected modules form a media scheduling and broadcasting system, and achieve the purpose of digital content retrieval, management, and broadcasting.

In an exemplary example, the media scheduling and broadcasting apparatus 50 includes a content capturing module 501 which is able to retrieve the various digital contents from the content source, preferably via a wired or wireless means. The apparatus 50 also includes a content management module 502, by which the digital content retrieved by the content capturing module 501 is searchable and browsable. Through this content management module 502, the information, including the file, predetermined broadcasting time, and the attribute of content, extracted from the digital content is accessible.

The media scheduling and broadcasting apparatus 50 further includes a channel management module 504. The channel management module 504 is connected with the content management module 502. The module 504 is used to configure the broadcasting channels, especially by means of software or hardware. The channels are configured to broadcast to digital content to the various terminal display devices at one time or different time.

The media scheduling and broadcasting apparatus 50 includes a program scheduling module 505 which is used to perform scheduling to the channels and set up the broadcasting time by means of software or hardware.

The apparatus 50 further includes a layout configuration module 507 which is used to arrange a layout on the display. It is featured that the layout configured by this layout configuration module 507 makes the content to be suitably displayed onto the display of each terminal display device.

A playback-end management module 508 is also included in the media scheduling and broadcasting apparatus 50. The playback-end management module 508 is used to manage the displays and their displaying conditions of the one or more terminal display devices. Therefore, the content, through this module 508, may be automatically regulated to a suitable mode, by which the content can be broadcasted adaptively by referring to the displaying conditions. The configured broadcasting channel, the corresponding object to be distributed, and the broadcasting time are collocated to broadcast the content to the terminal display device.

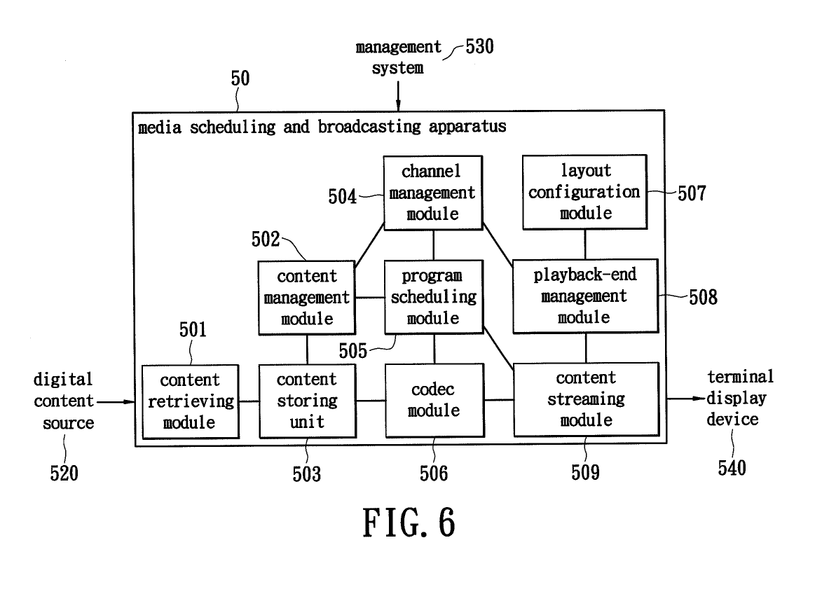

FIG. 6 describes the functional modules in one embodiment in accordance with the disclosure. Other than the implementation of FIG. 5, some further modules shown in FIG. 6 are provided in the apparatus according to one of the embodiments. The more modules are especially used to conduct encoding or decoding to the various digital contents in order to fit in with the every terminal display device, such as a codec module. A content streaming module is also provided to manage the streaming content. A file delivery module is provided to distribute the digital content in form of a file. The apparatus may include a content storing unit for storing the content.

One of the embodiments is referred to the figure describing the media scheduling and broadcasting apparatus 50, which may be implemented as a standalone computer system, or a cluster having a plurality of computer systems. One further scheme of the disclosure is to introduce a cloud-computing mechanism to implementing the scheduling and broadcasting for the digital content. The software modules or the related circuit units are described as follows.

According to one of the embodiments, the media scheduling and broadcasting apparatus 50 is preferably used to programmize the digital content and output it to the various terminal display devices. The apparatus 50 includes the shown content capturing module 501, content management module 502, content storing unit 503, channel management module 504, program scheduling module 505, codec module 506, layout configuration module 507, playback-end management module 508, and a content streaming module 509.

The content capturing module 501 may be an output and input system of the apparatus 50. Through a wired or wireless connection, the data from the digital content source 520 can be retrieved. The source 520 may be the many types of servers including a file server and a mail server, database, video player, the content over the network, or real-time TV program. The digital content can be text, document, video, audio, picture, or live signals. In accordance with the embodiment, the content capturing module 501 may automatically monitor and retrieve the content from the file server. Alternatively, the content may be extracted from the mail attached with the file and a calendar schedule in the mail server. Further, this content capturing module 501 is automatically linked with the program scheduling module 505 for providing files for further scheduling. Further, the live signals of TV program and the content over the network may also be retrieved by the content capturing module 501, and used for further scheduling. The retrieved content is then stored or buffered in the content storing unit 503.

In particular, the content may contain industrial news, department news, training information, meeting information, and others if the system is applied within an enterprise. Those contents may be separated to both public information and the personalized information.

The content management module 502 is used to manage the various contents. It is featured that the module 502 provides searching and browsing functions to the stored digital content. The searchable or browsable information includes the attribute of the content file, category regarding to the content, and the corresponding time information. The time information may include the broadcasting time and its valid period. The content is properly stored in a specific space. The mentioned broadcasting time may be a rough period and therefore a suitable time can be defined since the time is adjustable flexibly by referring to other contents.

The channel management module 504, connected with the content management module 502, is mainly used to configure one or more broadcasting channels for the digital content. The content is categorized into a specific type based on its attribute, and has its own channel according to the object desired to be broadcasted. In one embodiment, an administrator may use the management system 530 to access the channel management module 504 over the network. The system having the channel management module 504 provides a management interface for the administrator to manage the channels, including performing configuration and establishing the media channel.

Through the management system 530, the content management module 502 provides searching and browsing functions for administrator to find the content. The program scheduling module 505 is provided to schedule a program guide and times. The content is scheduled to a specific channel in accordance with the time information retrieved from the content. The administrator may configure the schedule for programs as required. Further, the information extracted from the server may be the reference to conduct the schedule. For example, the time information may be extract from the mail in the mail server. Then the program scheduling module 505 may accordingly schedule the content and the broadcasting time.

The codec module 506 is connected with the content storing unit 503 and the program scheduling module 505. The time and broadcasting content are set by the program scheduling module 505. The digital content is automatically converted to a format in compliance with a certain codec which is compatible to the every terminal display device 540. The conversion may be performed on resolution, size and format of the content. Through an encoding process, the content may be converted to a suitable format such as in form of streaming file for the content streaming module, or a file delivered to the terminal display device 540.

Before the broadcasting, the layout configuration module 507 is used to set up the layout for displaying. The layout configuration module 507 is mainly used to arrange the displaying layout of each terminal display device. The layout arrangement is for suitably displaying the content on the specific display.

The layout configuration module 507 may be collocated with the display type for each terminal device configured by the playback-end management module 508. The apparatus may be a PC-based platform, a mobile device, or merely an independent display. The PC-based platform may adopt a web browser to display the content. The mobile device may have its proprietary interface or software to display the content. The independent display may be used with a specific player.

The playback-end management module 508 is preferably used for managing the displays or the related conditions of one or more terminal display devices. Therefore, the apparatus may automatically regulate the way to broadcast the digital content.

For example, the software module adaptively modifies the broadcasting task in accordance with the digital content, program content, network status, the priority to play, and the necessity of the content. Therefore, the system may automatically modify the content and make it suitable to deliver. The above described broadcasting methods, such as streaming technology and directly delivering the file, are selectively applied to broadcast the digital content. It is noted that the connection to broadcast the content can be automatically resumed when the connection is failed.

The content streaming module 509 is used to receive the content with a streaming format coded by the codec module 506. The coded video is then broadcasted to the every terminal display device 540 in form of streaming. The streaming mechanism for broadcasting the content may reduce the requirement of large space of the each terminal display device for storing the content. The content to be distributed using the streaming mechanism can be real-time displayed, or alternatively via non real-time streaming. Different purposes may cause the system to establish different channels. For example, the streaming technology may be applied to broadcasting the live program. The video on demand (VOD) scheme may also be implemented by streaming technology. The streaming technology can be applied to conducting the interactive channel and online conference.

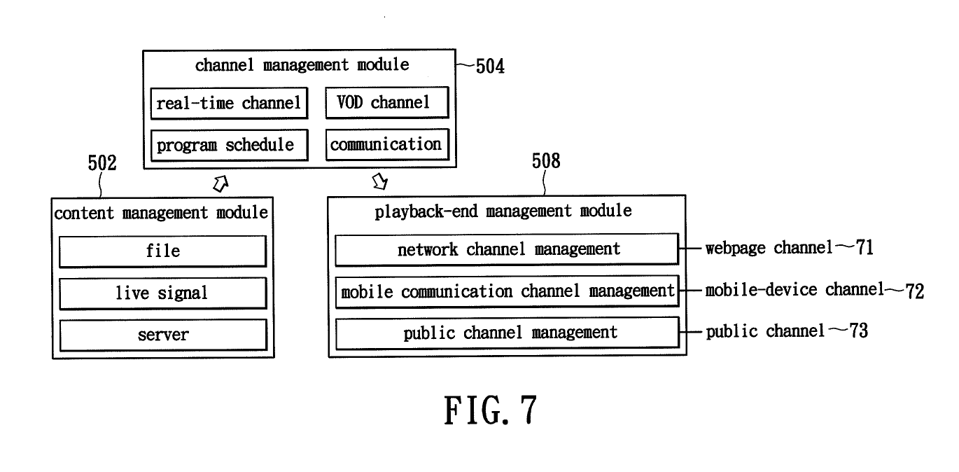

Operating kernel of the described software module shown in FIG. 5 and FIG. 6 at least includes a content management module 502, a channel management module 504, and a playback-end management module 508. FIG. 7 illustrates the interaction among the modules.

The content management module 502 is one of the software modules for managing the digital content including a file (video, picture, text), live signals (TV signals, radio), and signals retrieved from the various servers (mail server, file server). After that, the content may be forwarded to the channel management module 504.

The channel management module 504 is particularly used to categorize the digital content from the content management module 502 and accordingly establish channels. The content is then scheduled and delivered through the channel management module 504. The channel management module 504 also categorizes the real-time signals to a live channel. The video files may be categorized to a VOD channel. Those types of digital contents may be scheduled in accordance with requirement of distribution. The related channel information and program schedule may be forwarded to the playback-end management module 508 by a communication means.

The playback-end management module 508 broadcasts the digital contents through various channels based on the channel information and program schedule. The means of managing network channels shown in the diagram is introduced to broadcasting the content to the terminal display device over a network. The terminal display device may be a PC-based device, and therefore the content can be displayed as a web page through a webpage channel 71.

While the object to be broadcasted is a mobile device, the playback-end management module 508 uses a channel managing means to broadcast content to the mobile device over a mobile communication network. As shown in the diagram, the content is delivered to the each terminal device over a mobile-device channel 72.

While the object is public, the playback-end management module 508 uses public channel managing means to broadcast the content to the players disposed in some places via wired or wireless connection. Therefore, a public channel 73 is formed to broadcast the content onto the public bulletin board, or the display at public area.

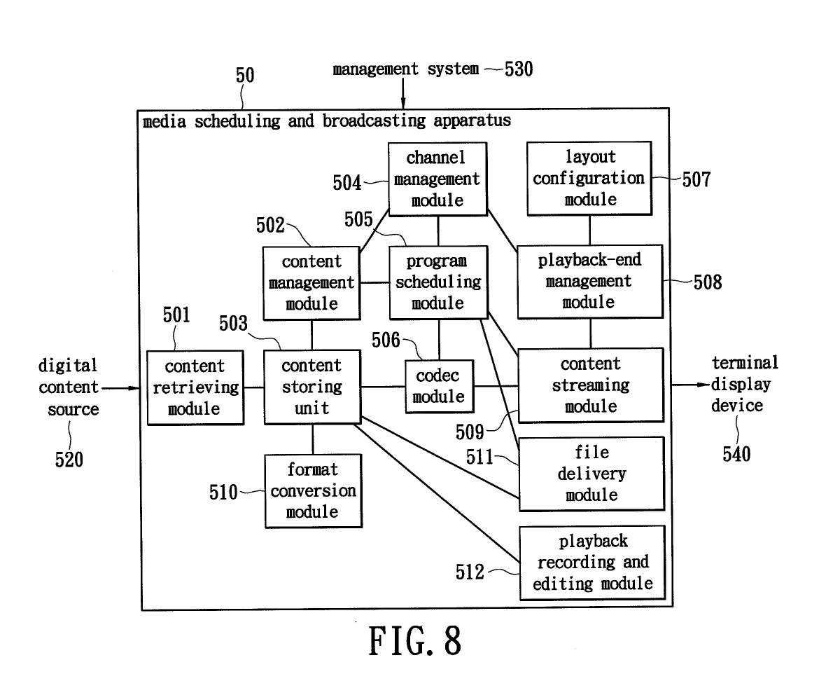

The mentioned media scheduling and broadcasting apparatus 50 may also incorporate some other software modules or the functional modules implemented by circuits. Reference is made to FIG. 8 describing the functional blocks.

The apparatus is expandable other than the description of the operation of the each software module in FIG. 5 or FIG. 6. A format conversion module 510 is in connection with the content storing unit 503. The format conversion module 510 is particularly used to perform format conversion to the content stored in the content storing unit 503. The conversion makes the digital content suitably displaying the content onto the terminal display device. For example, the bit rate and resolution of the multimedia content should be suitably converted to a specific format. The shown apparatus is particularly adapted to a local area network since the terminal devices within the network are easily controlled. The format conversion may be suitably performed on each device.

A file delivery module 511 can be further disposed in the apparatus. The file delivery module 511 is in connection with the program scheduling module 505, the content storing unit 503, and the playback-end management module 508. The media scheduling and broadcasting apparatus 50 may use streaming technology to broadcast the digital content to the terminal display device 540, and also deliver a content file retrieved from the content storing unit 503 to the device 540.

For example, while the terminal display device is a multimedia player, the file delivery module 511 may in accordance with schedule automatically deliver the digital content to the multimedia player over the network. Further, if the content is non-video file, such as picture and document, the content may properly be delivered in form of a file to the terminal device, or be displayed on a display.

A playback recording and editing module 512 may be further included in the apparatus. The playback recording and editing module 512 is in connection with the content storing unit 503. The module 512 is particularly used to record the content or screen image broadcasted from the media scheduling and broadcasting apparatus 50 automatically. In accordance with the time, the content is edited accordingly to be the file stored in the content storing unit 503. The stored content after editing may be reused for future scheduling. The recorded content may be the various digital contents including live program or the selectively downloaded content.

While the content recording is activated, the system may automatically record the playing multimedia. The recorded content extracted from the display of terminal device may be reproduced. After that, the system is configured to detect and eliminate the black frame. Further, the frame can be frozen. The recorded content is clipped and format-converted into new content automatically based on the configured time or image transformation. The conversion may involve the format conversion, bit-rate and resolution conversions. After that, the new content is stored in the content storing unit 503.

Furthermore, the apparatus may derive statistics of every broadcasting type from those software modules inside the apparatus. Further, the status of each terminal display end may be obtained and to find an optimal way of broadcasting for the terminal display device 540 exemplarily. The statistics may be a reference for future broadcasting service.

The terminal display device applied to the media scheduling and broadcasting system in the instant disclosure may be a PC-based device, which uses web page or proprietary software to display the broadcasted content. The display layout is configured by a system administrator who integrates each end's information through the above-described layout configuration module.

In an example of the terminal device being a bulletin board that has no any data processing ability such as computer system, an embedded system may be utilized to process decoding and displaying. Alternatively, the bulletin board may be connected with a player for processing signal conversion. The display layout may also be configured by the layout configuration module.

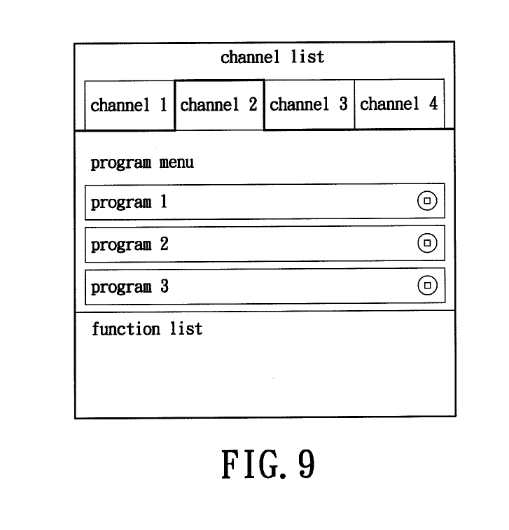

If the terminal display device is a mobile communication device such as a mobile phone, the display content and layout may be configured by an administrator through software means. Further exemplary embodiment is shown as FIG. 9 describing the function of interaction and customization of the received digital content.

The schematic diagram of the embodiment in accordance with the instant disclosure shows a media scheduling and broadcasting system. The digital content to be broadcasted may be a real-time playing content, video on demand, and selectively downloadable digital content. The each end user may receive a channel menu provided by the system via a mobile communication device. The content may also be official information. The content is also editable by the users, or be categorized as a list in the channel menu.

The figure shows a channel list which is created according to the attribute of content or personal interests. The exemplary example lists some channels on the display, such as channel 1, channel 2, channel 3, and channel 4, which may represent the categories. Each channel has a program menu presenting a specific category. The content of menu may be added or deleted through a function key on a function list. The shown channel 2 exemplarily includes program 1, program 2 and program 3.

Those contents may be stored in the memory of terminal device. The digital content linked with a specific option listed on the menu. The specific digital content will be instantly played as any user clicks one of the options on the menu. The content may be triggered to be played by a streaming method as the corresponding option is clicked. The media scheduling and broadcasting apparatus then broadcasts the content using a streaming technology.

In particular, the disclosed system may provide an automatic adjustment mechanism since the length of the content from the various sources may not exactly meet the scheduled playing period.

While the content is ready to broadcast, the system may automatically adjust the time to play the content according to the length of program. One the other hand, if the scheduled period is longer than the length of the content to be played, the system may repeat playing the content until the end of the schedule period. Furthermore, a clipping means may be introduced to program production and content separation. The interesting clip can be chosen to broadcast through the clipping means but not change any original content.

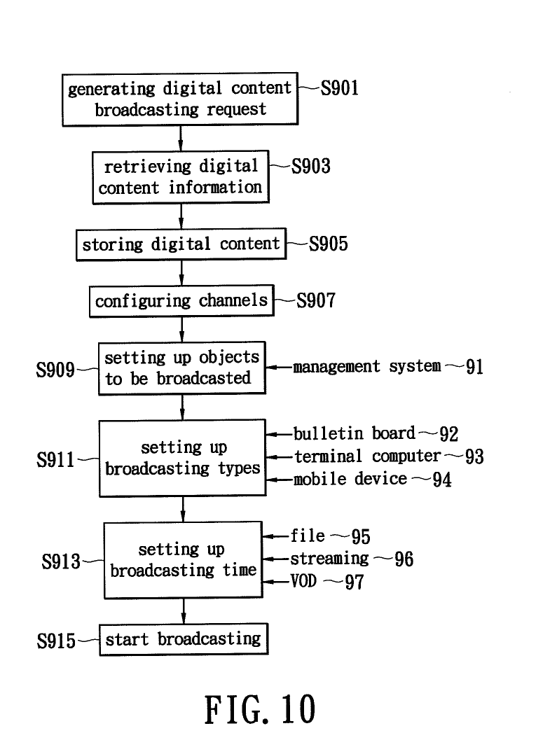

Reference is made to FIG. 10 illustrating an automatic scheduling method using the above-described media scheduling and broadcasting apparatus and system.

In step S901, a content broadcasting request is firstly generated. The request to actively broadcast the content may be generated from a management system as required. An administrator conducts the related configuration through an interface provided by the management system. It is particularly configured to set the broadcasting information of a specific content. Further, some servers may also generate the content broadcasting request.

In an exemplary embodiment, the media scheduling and broadcasting system uses a program to perform polling the mails queued in a mail server actively and periodically. The mail may contain the request of broadcasting a content set in schedule. The broadcasting information, such as broadcasting time and attribute of content, is then extracted from the mail.

Next, in step S903, that information can be retrieved after the system generates the broadcasting request. The information may include content source, object to be distributed, broadcasting time, attribute of digital content (size, format, codec method). The following step S905 allows the digital content to be stored in a content storing unit. If the digital content is a live video or audio signal, the content may be retrieved by the media scheduling and broadcasting apparatus and queued in a storage medium of the apparatus. In the current case, the storage medium is a buffer space for the live signals.

In step S907, a broadcasting channel is configured through the management system. The respective channel may be managed in accordance with the extracted content source, object to be distributed, broadcasting time, and attribute of digital content. Further, one new channel or any existed channel is also be the configured channel for the current example. The same digital content may not be necessary played in only one channel, but being broadcasted through a plurality of channels. It is noted that one channel may be configured based on the object to be broadcasted, or on the content attribute, or on the period for playing.

Next, such as step S909, the management system 91 is incorporated to configuring the one or more objects to be distributed according to the information extracted from the digital content and management. The objects to be distributed are the various terminal display devices, including public bulletin board 92 or a display, a terminal computer 93 with installation of a web browser or playing program, and particularly the mobile device 94 capable of receiving information anytime.

Next, in step S911, a type to broadcast is set in accordance with request and the content attribute. For example, if the content is one or more documents or pictures, they can be delivered in form of a file 95. The terminal display device may then display the content after receiving the content. If the content is a video, audio signals, or instant information, the content is suitably distributed by a streaming method 96. The streaming content can be firstly queued in a buffer memory of the terminal display device.

Those various digital contents may also be stored in the storage medium of the media scheduling and broadcasting apparatus. Then the users may take the content with type of video on demand 97, and play it anytime. Not only the contents can be retrieved from its original content source, but also from the data recorded while the apparatus plays the content. The recorded content can be reproduced for the future use.

Moreover, the media scheduling and broadcasting system may also support the channel types including live program channel, program on demand channel, interactive channel, and online meeting channel in addition to the above described types of file, streaming, and video on demand.

While the type to broadcast is set, one digital content may be broadcasted by the various types to broadcast at the same time. For example, if the broadcasting time is set during rush hour of network, the content may be selectively delivered in form of a file, or using streaming method. Also, the types to broadcast may be determined in accordance with the types of the terminal display devices. For example, since the bulletin board may not easily store the big-size file, it is properly using the streaming method to display the content. If the terminal display device is a terminal computer or a mobile device, the content may be selectively delivered in form of a file, but not limited to using the streaming method. When the content is broadcasted with different types, the system can simultaneously produce the file for video on demand service. Some other functions are provided by the system may include flexibly adjust the playing time and times to repeat by referring to the size of the content.

After the type to broadcast is determined, in step S913, the system is configured to set a broadcasting time. In which, the administrator may process the configuration through the management system, or in accordance with the time set in the original broadcasting request. One digital file may be used in more than one broadcasting times.

At last, such as step S915, the system starts to broadcast the content to the terminal devices according to the configured broadcasting channel, object to be distributed, type to broadcast, and time.

The instant disclosure is further related to a computer-readable recording medium for storing the instructions executing the steps illustrated in FIG. 10.

It is worth noting that the above-described apparatus, system and the related automatic scheduling and broadcasting method is provided in a single platform in an exemplary embodiment. This platform allows users to establish, schedule, and broadcast multimedia to the various terminal devices through channels. The broadcasted content serves as internal asset of organization or enterprise. The channels for broadcasting the content are constituted with low cost, but provide high efficient communication and information distribution. The scheme reduces the environmental limitation inside or outside the company. The invention is featured to integrate the content management and content distribution, and provide different formats for the various terminal devices. The method is automatically performed.

The apparatus, system and method of the instant disclosure at least have following achievements in accordance with the above description.

The media scheduling and broadcasting system applied to any organization or enterprise may be used to deliver specific message to specific objects for accomplishing clustering and flow division;

The scheme is provided for organization or enterprise to establish one or more mandatory and efficient content broadcasting channels for publishing information to specific objects;

The scheme is provided for establishing a platform for both internal and external communications within affordable cost;

The scheme is provided for gathering statistics of the end users' viewing behaviors and evaluating the benefit;

The content of enterprise may be efficiently retrieved and managed by this scheme.

To sum up the above description, disclosed herein is a scheme of media scheduling and broadcasting. An apparatus, a system, a related automatic channel scheduling method, and a computer-readable storage medium are thereby provided to manage the various digital contents through scheduling and channel establishment. The broadcasting content can be automatically formatted and output with respect to the various terminal display devices. The further program production and scheduling can be processed by the system. The objects to be distributed may be a variety of types of the terminal display devices, including public electronic display, bulletin board, handheld mobile device, and personal computer.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A media scheduling and broadcasting apparatus, comprising:
a content capturing module, retrieving digital content generated from a digital content source;
a content management module, providing the digital content for searching and browsing, wherein information retrieved from the digital content includes time information, and attribute of the digital content;
a channel management module, connected with the content management module, for configuring one or more broadcasting channels for the digital content;
a program scheduling module, in accordance with the time information of the digital content, for configuring a broadcast time and scheduling the digital content to the channel;
a layout configuration module, for configuring a layout of display of one or more terminal display devices; and
a playback-end management module , for managing the display and condition to play of the one or more terminal display devices, and automatically regulating a way to broadcast the digital content, and configuring the one or more terminal display according to the broadcasting channel, the terminal display device to be broadcasted, and the broadcasting time.

2. The apparatus according to claim 1, further comprising a codec module connected with the program scheduling module, wherein the codec module automatically performs a codec conversion of the digital content into a format adapted to the one or more terminal display devices according to a schedule made by the program scheduling module.

3. The apparatus according to claim 1, further comprising a content streaming module, which broadcasts the digital content the one or more terminal display devices in a streaming process in accordance with the configured broadcasting channel, the terminal display device to be broadcasted, and the broadcasting time.

4. The apparatus according to claim 1, further comprising a file delivery module, which broadcasts the digital content to a media player in form of a file in accordance with the broadcasting channel, the terminal display device to be broadcasted, and the broadcasting time.

5. The apparatus according to claim 1, further comprising a content storing unit used for storing the digital content retrieved from the digital content source.

6. The apparatus according to claim 5, further comprising a format conversion module, connected with the content storing unit storing the digital content, which converts the digital content in compliance with bit rate and resolution for any playback condition adapted to each terminal display device.

7. The apparatus according to claim 5, further comprising a playback recording and editing module, connected with the content storing unit, for automatically recording the digital content broadcasted from the media scheduling and broadcasting apparatus to each terminal display device.

8. The apparatus according to claim 1, wherein the digital content source is a file server, a mail server, live signals or from a network.

9. The apparatus according to claim 8, wherein the content capturing module automatically monitors the file server and receives content there-from.

10. The apparatus according to claim 8, wherein the content capturing module automatically receives a mail attached with a file and a calendar schedule from the mail server, and serially links to process of the program scheduling module for scheduling the file.

11. The apparatus according to claim 8, wherein the content capturing module is used to receive the live signals and retrieve the network streaming for further scheduling.

12. A media scheduling and broadcasting system, comprising:
(1) a digital content source, being a mail server;
(2) a media scheduling and broadcasting apparatus, comprising:
a content capturing module, retrieving digital content generated from the digital content source;
a content management module, providing the retrieved digital content for searching and browsing, and providing information related to the digital content including time information and attribute of the digital content;
a channel management module, connected with the content management module, for configuring one or more broadcasting channels for the digital content;
a program scheduling module, according to the retrieved time information of the digital content, for configuring a broadcast time and scheduling to the channel;
a layout configuration module, for configuring a layout on a display screen of one or more terminal display devices; and
a playback-end management module, for managing display and playing condition of the one or more terminal display devices, automatically regulating a way to deliver the digital content, and configuring the one or more terminal display devices according to configurations including a broadcasting channel, object to be broadcasted, and a broadcasting time;
(3) a management system, connected with the media scheduling and broadcasting apparatus, for accessing the media scheduling and broadcasting apparatus via a remote or local connection; and
(4) one or more terminal display devices, connected with the media scheduling and broadcasting apparatus, the terminal display device is a bulletin board, a terminal computer, or a mobile device.

13. The system according to claim 12, further comprising a codec module, connected with the program scheduling module, for automatically converting the digital content into a playing format adapted to the one or more terminal display devices according to a schedule of the program scheduling module.

14. The system according to claim 12, further comprising a content streaming module, which broadcasts the digital content to the one or more terminal display devices as a streaming file in accordance with the broadcasting channel, the object to be broadcasted, and the broadcasting time.

15. The system according to claim 12, further comprising a file delivery module, which delivers the digital content to a media player in form of a file in accordance with the broadcasting channel, the object to be broadcasted, and the broadcasting time.

16. The system according to claim 12, further comprising a content storing unit, which is used for storing digital content retrieved from the digital content source.

17. The system according to claim 16, further comprising a format conversion module format conversion module, connected with the content storing unit, for performing bit-rate and resolution conversion adapted to the playing condition of each terminal display device in reference to the digital content stored in the content storing unit.

18. The system according to claim 16, further comprising a playback recording and editing module , connected with the content storing unit, for automatically recording the digital content broadcasted to the each terminal display device from the media scheduling and broadcasting apparatus.

19. The system according to claim 12, wherein the management system has an operating interface provided for the media scheduling and broadcasting apparatus to perform channel management and configuration.

20. The system according to claim 12, wherein the digital content source is a file server, live signals, or a network.

21. The system according to claim 20, wherein the content capturing module automatically retrieves content of the file server through detection.

22. The system according to claim 20, wherein the content capturing module automatically retrieves a file and a calendar schedule attached with a mail from the mail server, and the content capturing module serially connects to the program scheduling module for scheduling the digital content.

23. The system according to claim 20, wherein the content capturing module retrieves the live signals and the streaming signals over the network, and the signals are prepared for further scheduling operations.

24. The system according to claim 12, wherein the media scheduling and broadcasting system supports the types of the content including video on demand, live broadcasting, media on demand, interactive channel and online conference beside configuring the file format and the way to broadcast the streaming signals.

25. A method for automatic scheduling for channels, comprising:
generating a request for content broadcasting request;
retrieving information of the digital content;
storing the digital content;
configuring one or more broadcasting channels of the digital content;
setting up one or more objects to be distributed for the digital content;
setting up one or more types to broadcast the digital content; and
setting up one or more broadcasting times to broadcast the digital content;
whereby, in compliance with the one or more broadcasting channels the digital content is broadcasted to one or more terminal display devices, the one or more objects to be distributed, the one or more types to broadcast, and the one or more broadcasting times.

26. The method according to claim 25, wherein the request for broadcasting the digital content is generated from a management system based on a requirement.

27. The method according to claim 26, wherein the digital content is broadcasted in compliance with the broadcasting time set from the management system.

28. The method according to claim 25, wherein the request to broadcast the digital content is generated in compliance with the schedule set up in an electronic mail extracted by accessing a mail server.

29. The method according to claim 28, wherein the broadcasting time of the digital content is extracted from the mail server.

30. The method according to claim 25, wherein information related to the digital content at least includes a content source, one or more objects to be distributed, a broadcasting time, and attribute for the digital content.

31. The method according to claim 30, wherein the step of configuring the broadcasting channel is in compliance with the content source, the one or more objects to be distributed, the broadcasting time, and the attribute of the digital content.

32. The method according to claim 31, wherein the configuration of the channel includes establishing a new channel or based on an existed channel.

33. The method according to claim 25, wherein the object to be distributed in compliance with the information of the digital content includes a bulletin board, a terminal computer, and/or a mobile device.

34. The method according to claim 25, wherein the step of setting up the type to broadcast comprises:
broadcasting the content in a form of a file if the digital content is one or more documents or pictures;
broadcasting the content using a streaming method if the digital content is a video, an audio file, or an instant message; and
storing the digital content in a form of video on demand.

35. The method according to claim 25, wherein the step of setting up the type to broadcast, the type to broadcast is decided in compliance with the type of the terminal display device, comprising:
broadcasting the digital content using a streaming method if the terminal display device is a bulletin board;
selectively broadcasting the digital content in a form of a file, or using the streaming method if the terminal display device is a terminal computer; and
selectively broadcasting the digital content in a form of a file or using the streaming method if the terminal display device is a mobile device; and
storing the digital content in a form of video on demand.

36. A computer-readable recording medium having computer-executable instructions for executing a method of automatically scheduling channels, wherein the method comprises:
generating a content broadcasting request;
retrieving information of digital content;
storing the digital content;
configuring one or more broadcasting channel for the digital content;
setting up one or more objects to be distributed of the digital content;
setting up one or more types to broadcast of the digital content; and
setting up one or more broadcasting times for the digital content;
whereby, the digital content is broadcasted to one or more terminal display devices in compliance with the setting one or more broadcasting channels, the one or more objects to be distributed, the one or more types to broadcast, and the one or more broadcasting times.
